(19) United States
(12) Patent Application Publication
(10) Pub. No.: US 2020/0314574 A1
(43) Pub. Date: Oct. 1, 2020

(54) DIAPHRAGM AND METHOD FOR MANUFACTURING SAME, AND SPEAKER

(71) Applicant: AAC Technologies Pte. Ltd., Singapore City (SG)

(72) Inventors: Ping Liang, Shenzhen (CN); Bin Zhao, Shenzhen (CN); Zhiwei Zhong, Shenzhen (CN)

(21) Appl. No.: 16/727,974

(22) Filed: Dec. 27, 2019

(30) Foreign Application Priority Data
Mar. 26, 2019 (CN) 201910234667.0

(51) Int. Cl. H04R 31/00; H04R 7/10; H04R 7/26; H04R 9/02; H04R 9/06

(52) U.S. Cl. CPC H04R 31/003; H04R 7/10; H04R 7/26; H04R 2307/025; H04R 9/06; H04R 2400/11; H04R 9/025

(57) ABSTRACT

The present invention provides a diaphragm. The diaphragm includes a polymer material layer made of a polymer material, and a porous damping material layer made of a porous damping material. The porous damping material layer is embedded in the polymer material layer. The present invention further provides a method for manufacturing the diaphragm including steps of preparing a polymer substrate plate and a porous damping substrate plate, respectively; and stacking and fixing the polymer substrate plate and the porous damping substrate plate by high temperature molding. The invention further provides a speaker using the diaphragm. The diaphragm has smaller amplitude deviation.

### FIELD OF THE PRESENT DISCLOSURE

The present invention relates to the field of electroacoustic devices, particularly to a diaphragm, and to a method for manufacturing the diaphragm. The present invention further relates to a speaker using the diaphragm.

### DESCRIPTION OF RELATED ART

At present, diaphragm is generally single-layer or composite materials such as silicone rubber, thermoplastic elastomer (TPE), thermoplastic polyurethane elastomer rubber (TPU), etc. These polymer materials have good elasticity with a small modulus, and are often used in the preparation of existing diaphragms. However, because these polymer materials are not resistant to high temperatures. When the temperature rises to a certain level (the product continues to vibrate or perform reliability experiments), in some products, the product amplitude becomes larger and larger, which causes deviations, results in product swing, then directly leads to product performance failure. FIG. 1 is the amplitude change diagram of respective vibration of 20 ms (millisecond) and 500 ms with material of diaphragm at different temperatures, 20 ms and 500 ms represent different time used to test the existing material of diaphragm in the same frequency phase interval, the longer the time, the more vibrations and the higher the product temperature. From the figure we can see the significant deviation of the vibration amplitude of same pint on the product using the existing diaphragm under the test conditions of 20 ms and 50 ms.

Accordingly, an improved diaphragm, and a speaker using the diaphragm are desired to solve the problems mentioned above.

### SUMMARY OF THE PRESENT INVENTION

One of the major objects of the present invention is to provide a diaphragm used in a speaker which can reduce the amplitude deviation under high temperature.

Another of the major objects of the present invention is to provide a method for manufacturing the diaphragm to reduce the amplitude deviation under high temperature.

A further one of the major objects of the present invention is to provide a speaker having the diaphragm.

For achieving the objects mentioned above, the present invention provides a diaphragm. The diaphragm includes a polymer material layer made of a polymer material and a porous damping material layer made of a porous damping material. The porous damping material layer is embedded in the polymer material layer.

In addition, a thickness of the polymer material layer is greater than a thickness of the porous damping material layer.

In addition, the polymer material layer comprises a first surface and a second surface opposite to the first surface, the porous damping material layer is disposed between the first surface and the second surface.

In addition, the porous damping material layer comprises a first side surface close to the first surface, a second side surface having a backside opposite to a backside of the first side surface; the porous damping material layer further comprises a plurality of through holes penetrating from the first side surface to the second side surface; the polymer material layer comprises a first polymer material layer stacked on the first side surface, a second polymer material layer stacked on the second side surface, and a polymer material embedded layer embedded in the through hole.

In addition, the first polymer material layer, the second polymer material layer, and the polymer material embedded layer are integrally assembled.

In addition, the polymer material layer is made of at least one of silicone rubber, thermoplastic elastomer, thermoplastic polyurethane elastomer rubber, polyetheretherketone, and polyethylene terephthalate.

In addition, the porous damping material layer is made of at least one material of polyphthalamide and polyetherketone.

The present invention further provides a method for manufacturing the diaphragm as mentioned above, and the method comprises steps of: preparing a polymer substrate plate and a porous damping substrate plate, respectively; stacking and fixing the polymer substrate plate and the porous damping substrate plate by high temperature molding.

The present invention further provides a speaker, comprising a magnetic circuit system, a vibration system and a frame provided with an accommodation cavity for receiving the magnetic circuit system and the vibration system.

The vibration system comprises a diaphragm as described above; the diaphragm connects to the top of the frame.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is a vibration amplitude change schematic diagram of existing diaphragm when vibrating respectively 20 ms and 500 ms at different temperatures;

FIG. 2 is an isometric view of a diaphragm in accordance with an exemplary embodiment of the present invention;

FIG. 3 is a front view of the diaphragm in FIG. 1;

FIG. 4 is a cross-sectional view of the diaphragm in FIG. 1;

FIG. 5 is a vibration amplitude change schematic diagram of the diaphragm provided in embodiment of the present invention vibrating respectively 20 ms and 500 ms under different temperatures;

FIG. 6 is an exploded view diagram of a polymer substrate plate and a porous damping substrate plate of the present invention after being stacked and before high temperature molding;

FIG. 7 is an isometric view of a speaker using the diaphragm of the exemplary embodiment, from one aspect;

FIG. 8 is a cross-sectional view taken along line A-A in FIG. 7.

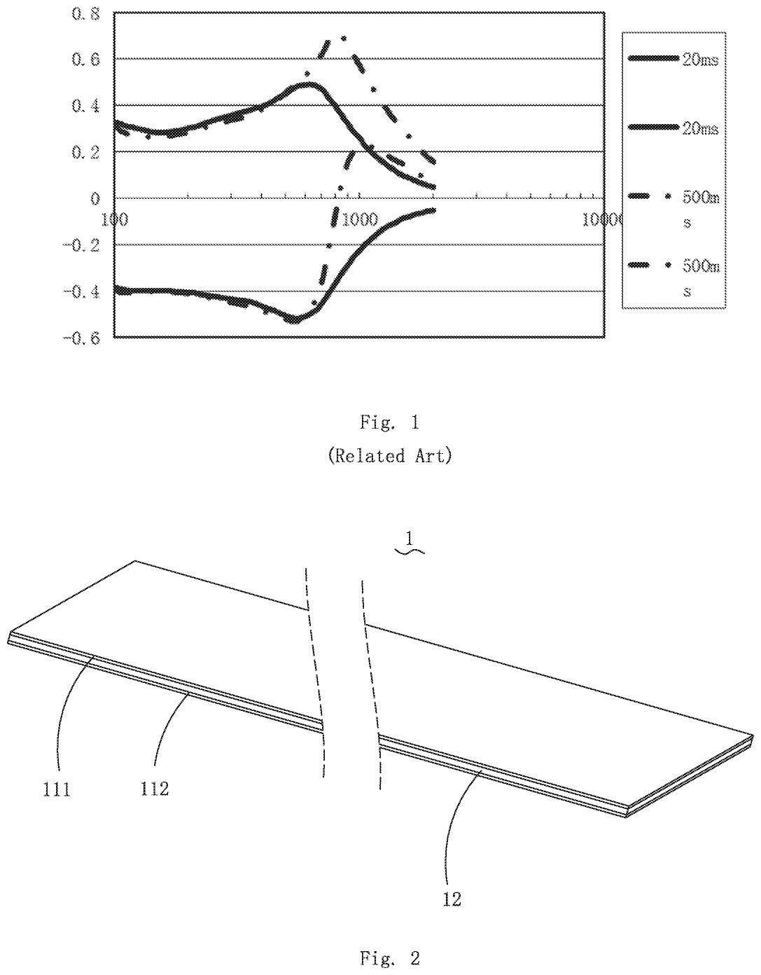

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

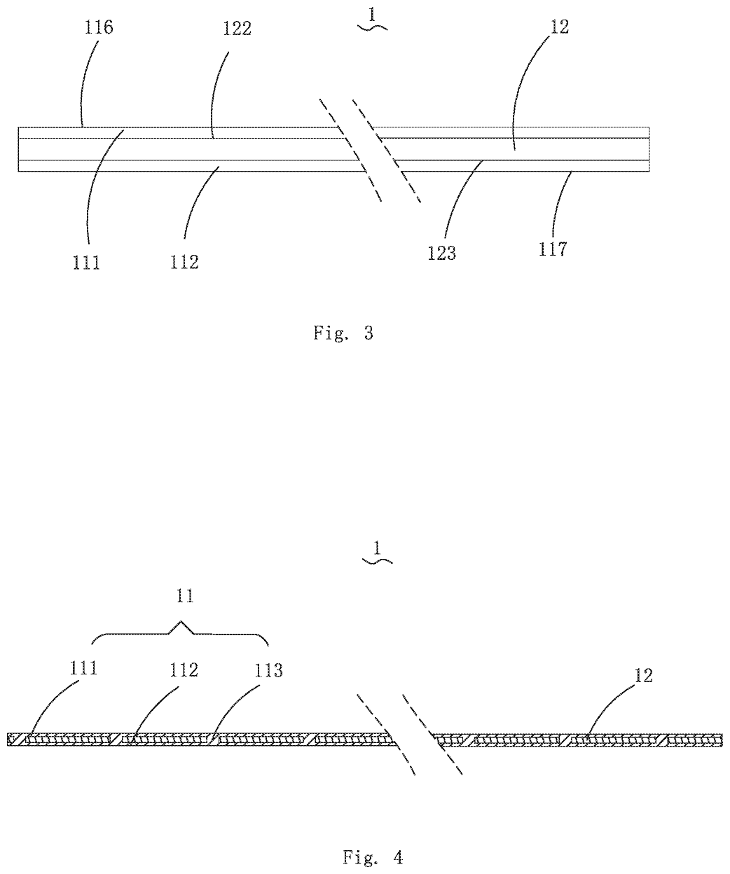

As shown in FIGS. 2-5, a diaphragm 1, provided in an embodiment of the present invention comprises polymer material layer 11 made of polymer material and porous damping material layer 12 made of porous damping material group, the porous damping material layer 12 is embedded in the polymer material layer 11. Because porous damping material layer 12 is added to diaphragm 1 in this embodiment, the porous damping material has high structural strength and can restrain the contractility of polymer materials, so that the dimensions of diaphragm 1 of this embodiment can be kept consistent. In addition, the diaphragm 1 of this embodiment can restrain and improve the performance variation of polymer materials under high temperature conditions, therefore, the amplitudes of products using the diaphragm 1 of this embodiment such as speakers have a smaller vibration deviation with increasing temperature, which improves product performance stability.

Preferably, a thickness of the polymer material layer 11 is greater than a thickness of the porous damping material layer 12. The polymer material layer 11 comprises a first surface 116 and a second surface 117 opposite to the first surface 116. In this embodiment, the porous damping material layer 12 is integrally embedded in the polymer material layer 11 and is arranged between the first surface 116 and the second surface 117.

In this embodiment, the porous damping material layer 12 comprises a first side surface 122 close to the first surface 116, a second side surface 123 whose backside is opposite to backside of the first side surface 122 and which is close to the second surface 117. The porous damping material layer 12 comprises a plurality of through holes 121 from the first side surface 122 through the second side surface 123.

The polymer material layer 11 comprises a first polymer material layer 111 stacked on the first side surface 122, a second polymer material layer 112 stacked on the second side surface 123, and a polymer material embedded layer 113 embedded in a through hole 121. The materials of the first polymer material layer 111, the second polymer material layer 112, and the polymer material embedded layer 113 are all the same and integrally molded, and the manufacturing process is simple. In this embodiment, the polymer material layer 11 lays through the through hole 121 and stacked layers are formed on both sides of the porous damping material layer 12 respectively. As an alternative embodiment, the following arrangements are also possible to the polymer material layer 11: the polymer material layer 11 may only include the first polymer material layer 111 stacked on the first side surface 122 and the polymer material embedded layer 113 embedded in the through hole 121, wherein, the polymer material embedded layer 113 can lay through the through hole 121 exactly, that is, the second surface 117 is parallel to and aligned with the second side surface 123. Alternatively, the polymer material embedded layer 113 may not lay through the through hole 121, that is, the second surface 117 is arranged in the through hole 121.

Preferably, the polymer material layer are made of at least one of silicone rubber, thermoplastic elastomer (TPE), thermoplastic polyurethane elastomer rubber (TPU), polyetheretherketone (PEEK), and polyethylene terephthalate (PET). These high-molecular materials have a relatively small elastic modulus and relatively good elasticity.

Preferably, the porous damping material layer is made of at least one of polyphthalamide and polyetherketone material,

These porous damping material have high structural strength and can restrain the variation of polymer material properties under high temperature conditions.

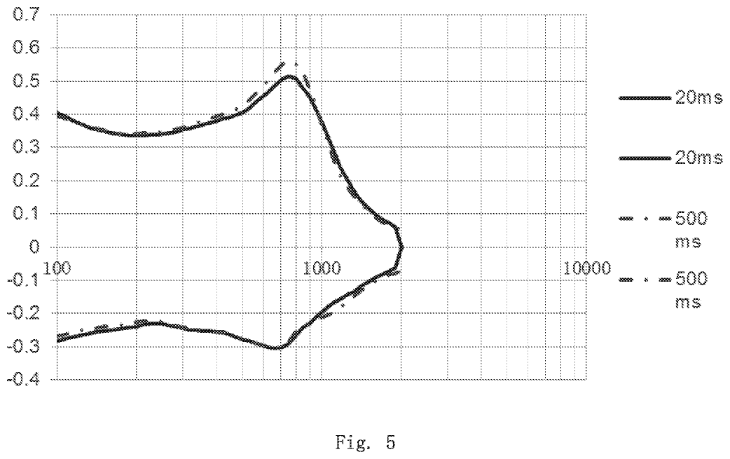

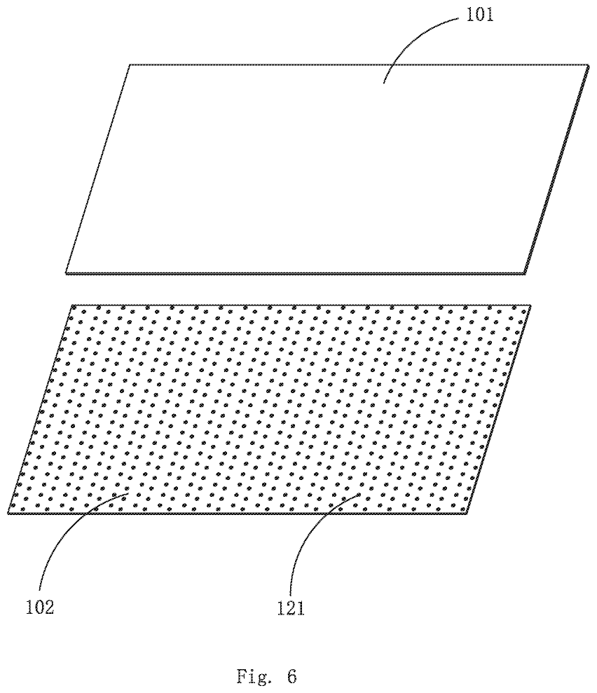

FIG. 5 is the amplitude change diagram of respective vibration of 20 ms and 500 ms with diaphragm 1 provided in this embodiment at different temperatures, 20 ms and 500 ms represent different time used to test the diaphragm 1 of this embodiment in the same frequency phase interval. We can see that the diaphragm 1 of this embodiment has a small amplitude deviation at the same point on the product under the test conditions of 20 ms and 50 ms.

This embodiment further provides a method for preparing the above-mentioned diaphragm 1, following steps are included.

Prepare polymer substrate plate 101 and porous damping substrate plate 102, respectively;

Form a diaphragm 1 by stacking and fixing the polymer substrate plate 101 and the porous damping substrate plate 102 by high temperature molding.

In this embodiment, as shown in FIG. 6, the number of the polymer substrate plate 101 and the porous damping substrate plate 102 are one and the thickness of the polymer substrate plate 101 is greater than the thickness of the porous damping substrate plate 102. First, polymer substrate plate 101 is stacked on the first side surface 122 of porous damping substrate plate 102, and then high temperature molding is performed, and the polymer material is embedded in through hole 121 of porous damping substrate plate 102 to form a polymer material embedded layer 113. The polymer material still stacked on the first side surface 122 of porous damping substrate plate 102 forms a first polymer material layer 111, and the porous damping substrate plate 102 forms a porous damping material layer 12. When the thickness of the polymer substrate plate 101 is large enough, after a long period of high-temperature molding has been performed, the polymer material will be embedded and penetrate through the through hole 121, and a second polymer material layer 112 is formed on the second side surface 123 of the porous damping substrate plate 102. In the present embodiment, the first side surface 122 of porous damping substrate plate 102 is the same as the first side surface 122 of porous damping material substrate 12, the second side surface 123 of the porous damping substrate plate 102 is the same as the second side surface 123 of the porous damping material layer 12.

The deviation of the vibration amplitude of the diaphragm 1 provided in this embodiment is small with increasing temperature, and the product performance is relatively stable.

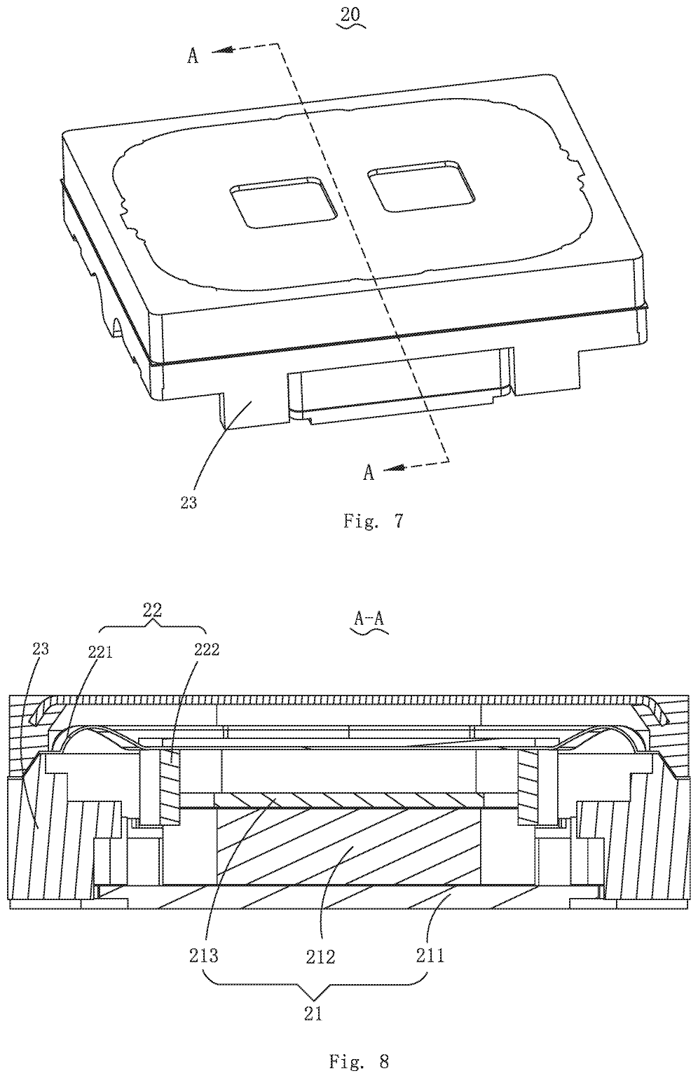

As shown in FIGS. 7-8, a speaker 20 provided in this embodiment comprises a magnetic circuit system 21, a vibration system 22, and a frame 23 with accommodation cavity. Both magnetic circuit system 21 and vibration system 22 are accommodated in the accommodation cavity. The vibration system 22 comprises a diaphragm 221 connected to the top of the frame 23. Wherein, the first polymer material layer 111 or the second polymer material layer 112 is arranged on the side of the diaphragm 221 near the frame 23. In a preferred embodiment, the magnetic circuit system 21 comprises a magnetic frame 211 connected to the bottom of the frame 23, a permanent magnet 212 accommodated in the magnetic frame 211, and a pole core 213 fixed on the top of the permanent magnet 212. The bottom of the permanent magnet 212 is fixed in the magnetic frame 211. The vibration system 22 comprises a diaphragm 221 connected to the top of the frame 23, and a voice coil 222 arranged at the bottom of the diaphragm 221 and positioned in the accommodation cavity. The voice coil 222 moves due to Ampere Force generated by the magnetic field produced by the magnetic circuit system 21, thereby driving the diaphragm 221 to vibrate up and down.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A diaphragm, comprising:
a polymer material layer made of a polymer material;
a porous damping material layer made of a porous damping material; wherein
the porous damping material layer is embedded in the polymer material layer.

2. The diaphragm as described in claim 1, wherein a thickness of the polymer material layer is greater than a thickness of the porous damping material layer.

3. The diaphragm as described in claim 1, wherein the polymer material layer comprises a first surface and a second surface opposite to the first surface, the porous damping material layer is disposed between the first surface and the second surface.

4. The diaphragm as described in claim 3, wherein the porous damping material layer comprises a first side surface close to the first surface, a second side surface having a backside opposite to a backside of the first side surface; the porous damping material layer further comprises a plurality of through holes penetrating from the first side surface to the second side surface; the polymer material layer comprises a first polymer material layer stacked on the first side surface, a second polymer material layer stacked on the second side surface, and a polymer material embedded layer embedded in the through hole.

5. The diaphragm as described in claim 4, wherein the first polymer material layer, the second polymer material layer, and the polymer material embedded layer are integrally assembled.

6. The diaphragm as described in claim 1, wherein the polymer material layer is made of at least one of silicone rubber, thermoplastic elastomer, thermoplastic polyurethane elastomer rubber, polyetheretherketone, and polyethylene terephthalate.

7. The diaphragm as described in claim 2, wherein the polymer material layer is made of at least one of silicone rubber, thermoplastic elastomer, thermoplastic polyurethane elastomer rubber, polyetheretherketone, and polyethylene terephthalate.

8. The diaphragm as described in claim 3, wherein the polymer material layer is made of at least one of silicone rubber, thermoplastic elastomer, thermoplastic polyurethane elastomer rubber, polyetheretherketone, and polyethylene terephthalate.

9. The diaphragm as described in claim 4, wherein the polymer material layer is made of at least one of silicone rubber, thermoplastic elastomer, thermoplastic polyurethane elastomer rubber, polyetheretherketone, and polyethylene terephthalate.

10. The diaphragm as described in claim 5, wherein the polymer material layer is made of at least one of silicone rubber, thermoplastic elastomer, thermoplastic polyurethane elastomer rubber, polyetheretherketone, and polyethylene terephthalate.

11. The diaphragm according to claim 6, wherein the porous damping material layer is made of at least one material of polyphthalamide and polyetherketone.

12. The diaphragm according to claim 7, wherein the porous damping material layer is made of at least one material of polyphthalamide and polyetherketone.

13. The diaphragm according to claim 8, wherein the porous damping material layer is made of at least one material of polyphthalamide and polyetherketone.

14. The diaphragm according to claim 9, wherein the porous damping material layer is made of at least one material of polyphthalamide and polyetherketone.

15. The diaphragm according to claim 10, wherein the porous damping material layer is made of at least one material of polyphthalamide and polyetherketone.

16. A method for manufacturing the diaphragm as described in claim 1 comprising steps of:
preparing a polymer substrate plate and a porous damping substrate plate, respectively;
stacking and fixing the polymer substrate plate and the porous damping substrate plate by high temperature molding.

17. A speaker, comprises:
a magnetic circuit system;
a vibration system;
a frame provided with an accommodation cavity for receiving the magnetic circuit system and the vibration system; wherein
the vibration system comprises a diaphragm as described in claim 1; the diaphragm connects to the top of the frame.
